(19) United States
(12) Patent Application Publication
(10) Pub. No.: US 2021/0031132 A1
(43) Pub. Date: Feb. 4, 2021

(54) DEODORIZING DEVICE FOR WASTE AIR FROM HOT AIR TREATMENT PLANTS FOR FOODSTUFF AND/OR ANIMAL FEED

(71) Applicants: Tatiana GUZUN, Compiegne (FR); Carlos Alberto Ramos DIOGO, Carcavelos (PT)

(72) Inventors: Tatiana GUZUN, Compiegne (FR); Carlos Alberto Ramos DIOGO, Carcavelos (PT)

(21) Appl. No.: 17/075,401

(22) Filed: Oct. 20, 2020

Related U.S. Application Data
(63) Continuation of application No. PCT/EP2019/060187, filed on Apr. 18, 2019.

(30) Foreign Application Priority Data
Apr. 20, 2018 (DE) 10 2018 109 612.7

(51) Int. Cl. B01D 46/00; B01D 53/00; B01D 53/04

(52) U.S. Cl. CPC B01D 46/0036; B01D 53/002; B01D 53/0407; B01D 2257/90; B01D 2253/102; B01D 2257/80; B01D 46/0038

(57) ABSTRACT

A deodorizing device for waste air from hot air treatment plants for foodstuff and/or animal feed, having a treatment unit with a housing which has a treatment chamber that can be flowed through and is arranged between at least one waste air intake connection and at least one waste air outlet connection. At least one capacitor element and an activated carbon filter element are arranged in the cross-section, which can be flowed through. At least one fresh air supply line opens into the treatment chamber, wherein the cross-section of the fresh air supply line that can be flowed through can be changed and/or closed by means of a motor-driven control valve. At least one filter element is also arranged downstream of the opening of the fresh air supply line into the treatment chamber.

This nonprovisional application is a continuation of International Application No. PCT/EP2019/060187, which was filed on Apr. 18, 2019, and which claims priority to German Patent Application No. 10 2018 109 612.7, which was filed in Germany on Apr. 20, 2018, and which are both herein incorporated by reference.

### BACKGROUND OF THE INVENTION

### Field of the Invention

The present invention relates to a deodorizing device for waste air from hot air treatment plants for foodstuff and/or animal feed.

### Description of the Background Art

Organic odorous substances which arise at a high temperature and in most cases are also loaded with a corresponding humidity and therefore cannot be simply discharged to the environment are created in particular in the hot air treatment for foodstuff and/or animal feed. While thorough filtering by condenser elements and multi-stage filters is obvious, this requires a lot of installation space and in particular excessive amounts of energy for the operation of the ventilators, since these elements form a formidable flow obstacle which has to be overcome.

### SUMMARY OF THE INVENTION

It is therefore an object of the present invention to provide an energy-efficient deodorizing device in which only a very minor concentration of odor-generating substances are discharged to the ambient air at the outlet of the waste stack.

The deodorizing device is in particular provided for the treatment of waste air from hot air treatment plants for foodstuff and/or animal feed. Said deodorizing device can however also be used in other fields of application where odor substances are contained as gas or vapor in hot waste air.

Using the deodorizing device according to the invention, a method for cleaning waste air from hot air treatment plants for foodstuff and/or animal feed is as follows:

A ventilator unit is switched on such that the waste air from connected hot air treatment plants is suctioned off by way of pipelines and is injected into a treatment chamber of a treatment unit. The ventilator unit generates an air flow which initially directs the suctioned waste air through at least one condenser element which is disposed in the treatment unit.

Depending on the ambient temperature and the air humidity of the suctioned waste air, the condenser element is air-cooled only by suctioned fresh air, or in the manner of a heat exchanger is configured such that said condenser element in a circuit which is separate from the waste air flow is passed through by a flow of a coolant.

Gaseous and vaporous proportions of the waste air are condensed in the condenser unit and are, in liquid form, discharged to the outside. The flow cross section above the condenser element is closed off by at least one filter element. The waste air, from which the condensable proportions have already been cleaned, at this location is additionally directed through at least one dry filter element.

In order for an efficient airflow to be generated, a waste stack in which a further ventilator unit for improved ventilation of the treatment chamber and for discharging the cleaned air to the environment is disposed preferably adjoins the treatment unit. A largely laminar airflow can be achieved on account of the two ventilator units which are disposed upstream and downstream of the treatment unit being electrically coupled and by tuning the volumetric flows which are in each case conveyed.

Particles or dust content in the shape of droplets which have not condensed and have in particular been entrained from the condenser stage are separated by a droplet separator and/or a further pre-filter element. The waste air which by now is largely dry and exits from said droplet separator is finally directed through at least one activated carbon filter so as to separate organic gaseous ingredients of the waste air which contribute toward the formation of odor.

The cleaning of waste air by condensation, separation, and filtration stages however represents only one component part of the concept according to the invention for reducing odor.

A large proportion of the odor-forming substances is indeed already separated from the waste air by the condensation and filtration, but multi-staged filtration would in many specific applications be required in order to achieve residual concentrations of the odor-forming substances below the respective detection threshold. However, two substantial disadvantages would be associated with even more filter elements, specifically a high consumption of energy in order for the quantity of waste air to be forced by powerful ventilators through the numerous flow obstacles which are formed by the condenser and filter elements, on the one hand, and a high consumption in terms of filter media, on the other hand.

The invention here follows another path in that said invention performs the filtration only to the extent that waste air which has already cooled and has gaseous residual proportions of odorous substances is present, and in that said invention otherwise provides a fresh air intake line having a variable cross-section and moreover performs a dilution of the waste air. A complete elimination of the odorous substances and a chemically pure waste air is actually not even required in the envisaged fields of application since the odor-forming substances which are created in the treatment of foodstuff and animal feed are non-toxic and neither environmentally harmful nor hazardous to health, at least not in the case of minor concentrations. Moreover, the odorous substances are only found by people to be an unpleasant olfactory stimulation when present in high concentrations.

The cross-sectional variation is achieved by a motorized adjustment valve which, like the ventilator unit and the deaeration unit which is optionally additionally present, can be connected to a closed-loop control unit. Sensors which are in particular disposed in the profile of the waste stack and measure the specific concentration of substances can also be additionally connected.

Diluting the waste air is largely achieved on account of the fresh air intake line. The fresh air intake line in the suction port thereof can also be provided with a pre-filter such that largely pure fresh air which does not additionally stress the filter media in the treatment chamber is supplied to the treatment chamber. In contrast, the proportion of fresh air in the waste air leads to the harmful substances being more finely distributed before said harmful substances are directed through the filter media. The lateral introduction of the fresh air herein is likewise of particular importance since an additional flow which is transverse to the main flow direction of the waste airflow is thus generated in the treatment chamber. The waste air on account thereof is better distributed in the treatment chamber, and the available surfaces of the condenser element as well as of the filter elements are better utilized.

A further effect of the fresh air intake directly on the lateral wall of the treatment chamber is the cooling effect. Cooling, and potentially condensing, of the gaseous and vaporous proportions in the waste air takes place already on account of the supplied fresh air. Constant cooling of the condenser element takes place by the fresh air in any case. The humidity which is additionally introduced by the fresh air can additionally bind harmful substances in the form of gas, dust, or droplets in the waste air. The cooling and condensing effect on account of the introduced fresh air is insufficient only when the room air temperature is excessive, specifically in particular more than approximately 25° C. and when the humidity of the fresh air supplied from the outside is simultaneously insufficient, specifically in particular less than 70%, and the condensation output has to be achieved by active cooling of the condenser element which is incorporated in a coolant circuit.

However, as long as sufficiently cool and humid fresh air is available, the operation of a chiller can be dispensed with such that the power requirement for the operation is minor.

When the desired residual concentration in terms of odorous substances can be achieved by way of a minor pollution by fresh air, the fresh air intake is stopped or reduced in that the motorized adjustment valve varies the cross section.

The condensate arising is preferably decanted, preferably in an automatic manner, so as to separate aqueous component parts from oleaginous component parts, for example. To the extent that the fractions of the condensate thus obtained cannot be directly recycled or be utilized for other purposes, said fractions can also be used for humidifying the initial material provided for treatment in the hot air treatment plant prior to the treatment and/or being able to separate more soluble substances during the treatment in the following hot air treatment. It is also possible for post-humidification to be performed after the treatment by means of adding the condensate again. In this circuit, only those substances such as water with odorous molecules or oils which have previously been separated are supplied back to the foodstuff or the animal feed. No foreign material is thus introduced, and a natural circuit by way of which the quantities of waste material can be significantly reduced, or waste material can even be entirely avoided, is formed.

In summary, the advantages of diluting the pre-filtered waste air by a fresh air intake into the treatment chamber are as follows:

The results of the condensation for volatile component parts in the waste air are improved on account of continuous cooling and water vapor which is additionally introduced.

The throughput performance of the condenser element as well as of the filter element is improved, because the available surfaces are completely utilized, specifically also in the peripheral regions, on account of turbulences in the treatment chamber.

A dilution which substantially reduces the concentrations of the odorous substances in the waste air guided out of the treatment unit is achieved on account of the fresh air intake.

A system which is highly efficient and can likewise be used in a diverse manner and requires only a minor installation space and consumes little power when in operation is thus overall obtained by way of the deodorizing device according to the invention.

The treatment unit with the condenser element and the pipeline and stack lines are preferably formed from stainless steel in order for the system to be configured such that the latter is resistant to corrosion and easy to clean. The ventilator unit preferably comprises air-guiding parts and a fan from polypropylene so that a grease mist etc. adheres to these parts only to a minor extent and easy cleaning is possible.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a deodorizing device in a schematic lateral view;

FIG. 2 shows the treatment unit in a perspective view;

FIG. 3 shows the partially opened and sectioned treatment unit without the upper part;

FIG. 4 shows the treatment unit with an insert element which has been partially pulled out; and

FIG. 5 shows a filter unit.

### DETAILED DESCRIPTION

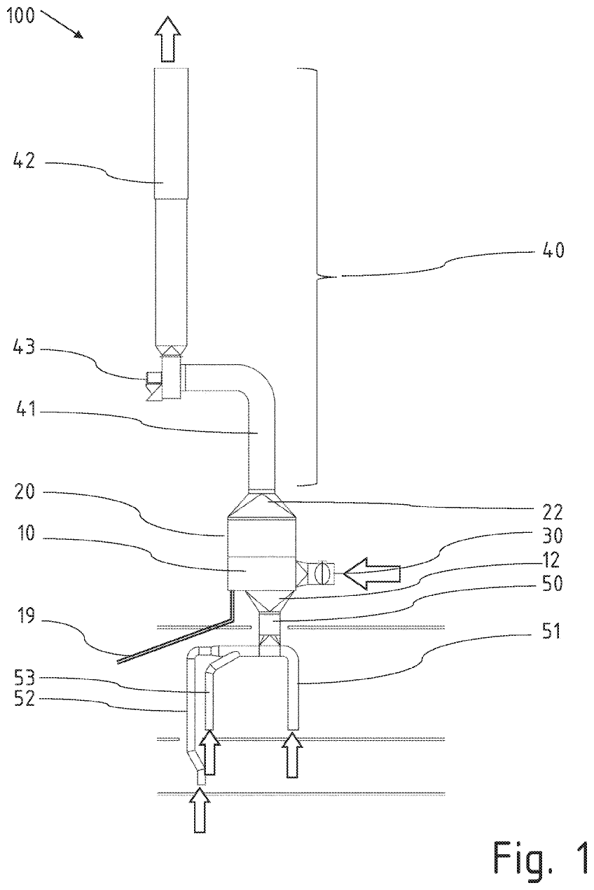

FIG. 1 shows a deodorizing device in a schematic lateral view. A plurality of pipelines 51, 52 which are connected to ventilation openings of various hot air treatment plants for foodstuff and/or animal feed are disposed in the lower region. The pipelines 51, 52, 53 combine so as to form a common intake line which is connected to a ventilator unit 50. The ventilator unit 50 in turn is connected directly to a waste air inlet port 12 of a treatment unit 10 which moreover has a waste air outlet port 22 on the upper side. A fresh air intake line 30 leads laterally into the treatment unit 10. A waste stack 40 which comprises a first sub-portion 41 and a second sub-portion 42 adjoins above the waste air outlet port 22. A deaeration unit 43 which likewise contains at least one ventilator is disposed therebetween.

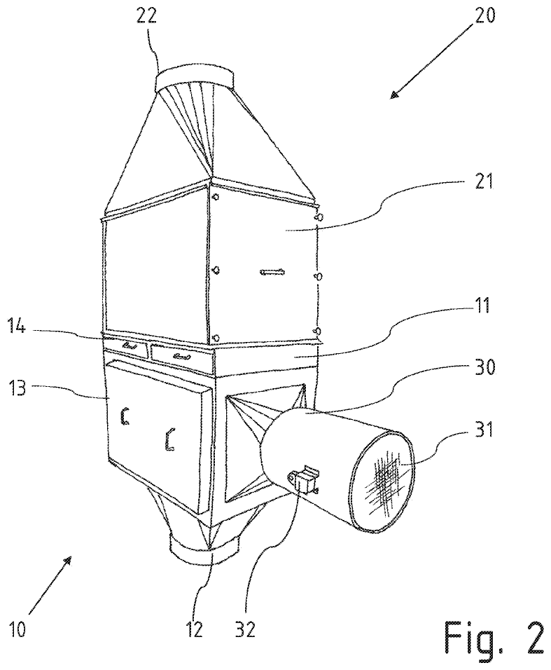

The treatment unit 10 is illustrated in a perspective view in FIG. 2. Said treatment unit 10 is composed substantially of a housing 11 having the waste air inlet port 12 and a fresh air intake line 30 which opens laterally into the housing 11. The cross section of the housing 11 is open toward the top. The filter housing 20 which toward the top tapers so as to form a waste air outlet port 22 adjoins the housing 11 directly in the exemplary embodiment illustrated.

A maintenance flap 13 by way of which the treatment chamber on the inside is accessible is provided in a lateral wall in the housing 11 of the treatment unit 10. Two drawer-type insert elements 14 into which filter elements are inserted are provided thereabove.

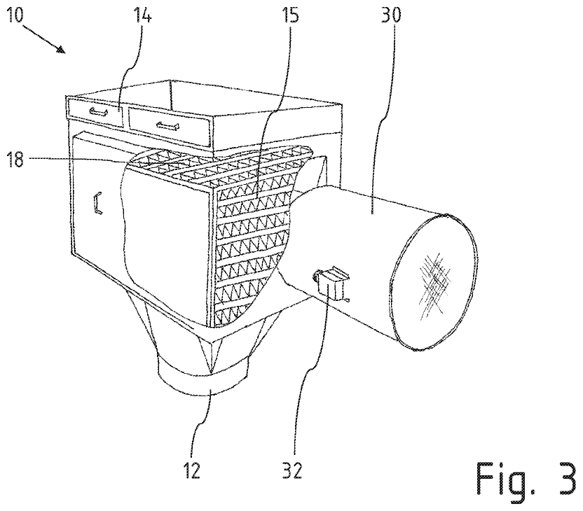

FIG. 3 shows the partially opened and sectioned treatment unit 10 without the upper part, thus without the filter unit. A condenser element 15 is inserted in the treatment chamber 18 in the interior of the housing 11.

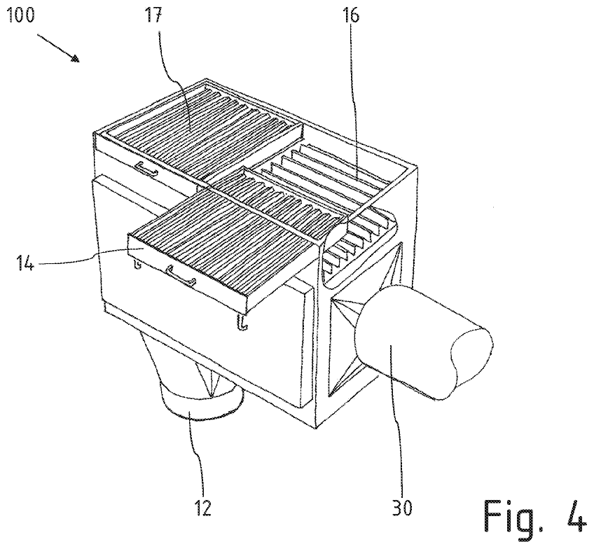

FIG. 4 again shows the treatment unit 10 having an insert element 14 which has been partially pulled out. A droplet separator element 17 is disposed in the insert element 14. An additional pre-filter 16 is placed on the condenser element 15 so as to be below the insert element 14, said condenser element 15 not being visible here.

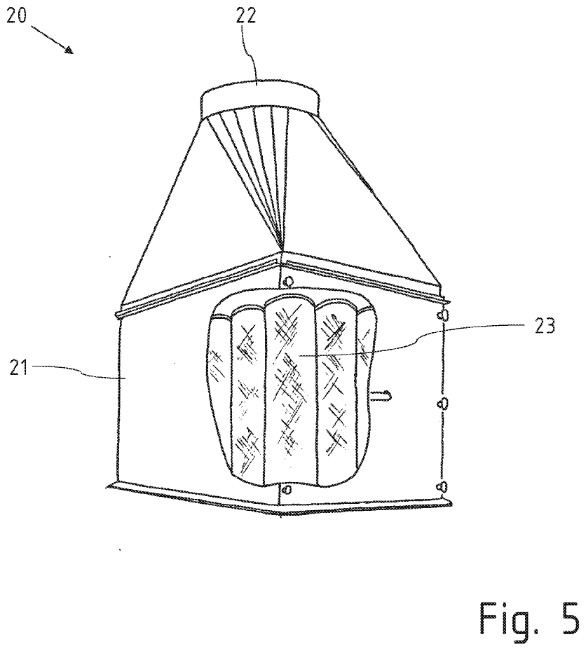

FIG. 5 shows a filter unit 20 having the housing 21 and the waste air outlet port 22, wherein the housing wall is partially cut out such that the filter elements 23 lying therebehind are visible. Said filter elements 23 are tubular filter elements 23 having an activated carbon layer which can be passed through by a flow.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A deodorizing device for waste air from hot air treatment plants for foodstuff and/or animal feed, the deodorizing device comprising:
a treatment unit having a housing that has a treatment chamber adapted to be passed through by a flow and being disposed between at least one waste air intake port and at least one waste air outlet port, wherein at least one condenser element and an activated carbon filter element being disposed in the cross section of the treatment unit that is adapted to be passed through by the flow;
a ventilator unit to direct the waste air through the treatment unit;
at least one fresh air intake line opening into the treatment chamber, a cross section of the fresh air intake line being adapted to be passed through by the flow is variable and/or closable via a motor-driven adjustment valve; and
at least one filter element disposed downstream of the opening of the fresh air intake line into the treatment chamber.

2. The deodorizing device as claimed in claim 1, wherein the condenser element is connected to a cooling circuit.

3. The deodorizing device as claimed in claim 1, wherein at least one pre-filter element is disposed ahead of the activated carbon filter element in the treatment unit.

4. The deodorizing device as claimed in claim 1, wherein at least one droplet separator element is disposed ahead of the activated carbon filter element in the treatment unit.

5. The deodorizing device as claimed in claim 1, wherein the ventilator unit is disposed upstream so as to be below the treatment chamber.

6. The deodorizing device as claimed in claim 1, wherein the ventilator unit comprises air-guiding parts and at least one fan which are composed of polypropylene.

7. The deodorizing device as claimed in claim 1, wherein a waste stack is connected to the waste air outlet port.

8. The deodorizing device as claimed in claim 7, wherein at least one deaeration unit having a further ventilator unit is disposed in a profile of the waste stack.

9. The deodorizing device as claimed in claim 1, wherein ventilator units that are disposed upstream and downstream of the treatment unit are connected to a common closed-loop control unit.

10. The deodorizing device as claimed in claim 9, wherein a motorized adjustment valve that is connected to the closed-loop control unit is provided for varying the cross section of the fresh air intake line.

11. The deodorizing device as claimed in claim 1, wherein at least one sensor for measuring a substance concentration is disposed in the profile of the waste stack.

12. A method for cleaning waste air from hot air treatment plants for foodstuff and/or animal feed by means of a deodorizing device as claimed in claim 1, the method comprising:
suctioning the waste air from at least one hot air treatment plant via the ventilator unit;
guiding an air flow that contains the suctioned waste air through at least one air-cooled or liquid-cooled condenser element that is disposed in the treatment unit;
separating gaseous and vaporous proportions of the waste air by condensation on the condenser element, and discharging the gaseous and vaporous proportions in liquid form to the outside;
injecting the waste air pre-filtered and cooled in the condenser element into the treatment chamber;
diluting the waste air by directing fresh air into the treatment chamber; and
extracting the diluted waste air.

13. The method as claimed in claim 12, wherein ventilator units that are disposed upstream and downstream of the treatment unit by way of a closed-loop control unit are coupled to one another in such a manner that a laminar air flow is achieved in the volumetric flows which are in each case conveyed through the ventilator units.
